(19) United States
(12) Patent Application Publication
(10) Pub. No.: US 2020/0175634 A1
(43) Pub. Date: Jun. 4, 2020

(54) METHODS, SYSTEMS, AND MEDIA FOR COORDINATING PARKING AVAILABILITY

(71) Applicant: Sidewalk Labs LLC, New York, NY (US)

(72) Inventors: Rohit Thomas Aggarwala, New York, NY (US); Willa Ng, New York, NY (US); Dan Riegel, Brooklyn, NY (US); Veronica Pinchin, New York, NY (US); Tom Kennedy, Brooklyn, NY (US); Ryan Vilim, Brooklyn, NY (US); David Katz, New York, NY (US)

(21) Appl. No.: 16/703,688

(22) Filed: Dec. 4, 2019

Related U.S. Application Data
(60) Provisional application No. 62/775,352, filed on Dec. 4, 2018.

(51) Int. Cl. G06Q 50/30; G06Q 10/02

(52) U.S. Cl. CPC G06Q 50/30; G06Q 10/02

(57) ABSTRACT

Methods, systems, and media for coordinating parking availability are provided. In some embodiments, the method comprises: receiving, at a server, information indicating a number of available parking spots in a parking garage during a time window; receiving, from a first user device via an instance of an application executing on the first user device, a request to reserve a parking spot in the parking garage during the time window; determining whether the parking spot is available during the time window based on the received information; in response to determining that the parking spot is available during the time window, updating parking availability information to indicate that the parking spot has been reserved during the time window; causing the reservation of the parking spot to be indicated via an instance of the application executing on a second user device; and transmitting, from the server to a dynamic sign during the time window, instructions that cause the dynamic sign to present a message that indicates at least the parking availability information.

### CROSS REFERENCE TO RELATED APPLICATION

This application claims the benefit of U.S. Provisional Application No. 62/775,352, filed Dec. 4, 2018, which is hereby incorporated by reference herein in its entirety.

### TECHNICAL FIELD

The disclosed subject matter relates to methods, systems, and media for coordinating parking availability.

### BACKGROUND

Parking can be a major source of traffic congestion, particularly in busy cities and towns. For example, cars circling a particular area looking for a parking spot on a street can cause traffic to slow down and/or back up. In some cases, it may be useful for drivers or vehicles to be alerted to available parking spots. However, it can be difficult to identify available parking spots and indicate available parking spots to drivers. For example, it can be difficult to accurately determine where available spots are located. As another example, it can be difficult for drivers to identify available spots in a timely manner.

Accordingly, it is desirable to provide new methods, systems, and media for coordinating parking availability.

### SUMMARY

Methods, systems, and media for coordinating parking availability are provided.

In accordance with some embodiments of the disclosed subject matter, a method for coordinating parking availability is provided, the method comprising: receiving, at a server, information indicating a number of available parking spots in a parking garage during a time window; receiving, from a first user device via an instance of an application executing on the first user device, a request to reserve a parking spot in the parking garage during the time window; determining whether the parking spot is available during the time window based on the received information; in response to determining that the parking spot is available during the time window, updating parking availability information to indicate that the parking spot has been reserved during the time window; causing the reservation of the parking spot to be indicated via an instance of the application executing on a second user device; and transmitting, from the server to a dynamic sign during the time window, instructions that cause the dynamic sign to present a message that indicates at least the parking availability information.

In some embodiments, the method further comprises: receiving, at the server via one or more sensors, information indicating a presence of a vehicle associated with the request to reserve the parking spot at a time point outside of the time window; and transmitting a message to a second server that indicates that the vehicle has been detected at the parking spot outside of the time window.

In some embodiments, the method further comprises: identifying a second parking spot that is available in the parking garage; and transmitting instructions to a light source that cause the light source to emit a light pattern that indicates the availability of the second parking spot.

In some embodiments, the method further comprises: receiving information indicating that an event is to be held at a location within a predetermined proximity to the parking garage during a second time window; identifying a plurality of parking spots in the parking garage; and updating the parking availability information to indicate that the plurality of parking spots have been reserved during the second time window.

In some embodiments, the method further comprises transmitting instructions to a light source that cause the light source to emit a light pattern, during the second time window, that indicate that the plurality of parking spots are unavailable.

In some embodiments, the method further comprises causing indications of the unavailability of the plurality of parking spots to be indicated in the instance of the application executing on the first user device and the instance of the application executing on the second user device.

In some embodiments, the method further comprises receiving, at the server from a plurality of sensors, information indicating a number of vehicles within a predetermined proximity to the parking garage.

In accordance with some embodiments of the disclosed subject matter, a system for coordinating parking availability is provided, the system comprising a server including a hardware processor that is configured to: receive, at the server, information indicating a number of available parking spots in a parking garage during a time window; receive, from a first user device via an instance of an application executing on the first user device, a request to reserve a parking spot in the parking garage during the time window; determine whether the parking spot is available during the time window based on the received information; in response to determining that the parking spot is available during the time window, update parking availability information to indicate that the parking spot has been reserved during the time window; cause the reservation of the parking spot to be indicated via an instance of the application executing on a second user device; and transmit, from the server to a dynamic sign during the time window, instructions that cause the dynamic sign to present a message that indicates at least the parking availability information.

In accordance with some embodiments of the disclosed subject matter, a non-transitory computer-readable medium containing computer executable instructions that, when executed by a processor, cause the processor to perform a method for coordinating parking availability is provided, the method comprising: receiving, at a server, information indicating a number of available parking spots in a parking garage during a time window; receiving, from a first user device via an instance of an application executing on the first user device, a request to reserve a parking spot in the parking garage during the time window; determining whether the parking spot is available during the time window based on the received information; in response to determining that the parking spot is available during the time window, updating parking availability information to indicate that the parking spot has been reserved during the time window; causing the reservation of the parking spot to be indicated via an instance of the application executing on a second user device; and transmitting, from the server to a dynamic sign during the time window, instructions that cause the dynamic sign to present a message that indicates at least the parking availability information.

In accordance with some embodiments of the disclosed subject matter, a system for coordinating parking availability is provided, the system comprising: means for receiving, at a server, information indicating a number of available parking spots in a parking garage during a time window; means for receiving, from a first user device via an instance of an application executing on the first user device, a request to reserve a parking spot in the parking garage during the time window; means for determining whether the parking spot is available during the time window based on the received information; means for updating parking availability information to indicate that the parking spot has been reserved during the time window in response to determining that the parking spot is available during the time window; means for causing the reservation of the parking spot to be indicated via an instance of the application executing on a second user device; and means for transmitting, from the server to a dynamic sign during the time window, instructions that cause the dynamic sign to present a message that indicates at least the parking availability information.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative example of a schematic diagram for coordinating parking availability in accordance with some embodiments of the disclosed subject matter.

FIG. 2 shows another illustrative example of a schematic diagram for coordinating parking availability in accordance with some embodiments of the disclosed subject matter.

FIG. 3 shows an illustrative example of a process for coordinating parking availability in accordance with some embodiments of the disclosed subject matter.

FIG. 4 shows a schematic diagram of an illustrative system for coordinating parking availability in accordance with some embodiments of the disclosed subject matter.

FIG. 5 shows a detailed example of hardware that can be used in a server and/or a device of FIG. 4 in accordance with some embodiments of the disclosed subject matter.

### DETAILED DESCRIPTION

In accordance with various embodiments, mechanisms (which can include methods, systems, and media) for coordinating parking availability are provided.

In some embodiments, the mechanisms described herein can detect available parking spots, allow vehicles (either legacy vehicles with a human driver or an autonomous vehicle) to reserve an available spot, determine whether parked vehicles are legally parked in valid parking spots, and/or control messaging systems that provide information related to parking spots.

For example, in some embodiments, the mechanisms described herein can use any suitable sensors to detect available parking spots. As a more particular example, in some embodiments, the mechanisms described herein can receive data from one or more cameras that determine whether particular parking spots are currently occupied. As another more particular example, in some embodiments, the mechanisms can receive data from one or more sensors (e.g., in-pavement sensors, lidar, radar, sonar, and/or any other suitable type of sensors) that detect whether particular parking spots are currently occupied.

As another example, in some embodiments, the mechanisms described herein can store indications of the current status of a group of parking spots. As a more particular example, in some embodiments, the mechanisms can update, in real-time, whether each parking spot in a group of parking spots is occupied. In some embodiments, a database that stores a status of parking spots can be used by an application (e.g., an application that can be accessed by a mobile device, an application that can be accessed by an autonomous vehicle, and/or any other suitable application) to reserve a particular parking spot.

As yet another example, in some embodiments, the mechanisms described herein can be used to determine whether a vehicle is legally parked. As a more particular example, in some embodiments, the mechanisms can receive a license plate number of a vehicle parked in a particular parking spot and can determine whether the license plate number matches a license plate of a vehicle associated with a payment for the parking spot and/or that is associated with a reservation for the parking spot. In some such embodiments, in response to determining that a vehicle is not legally parked, the mechanisms can transmit an indication to any suitable enforcement agency or entity.

As still another example, in some embodiments, the mechanisms described herein can control any suitable messaging system related to parking spots. As a more particular example, in some embodiments, the mechanisms described herein can control a dynamic sign that indicates any suitable information related to parking, such as a cost of a parking spot, a number of available parking spots in a particular area, and/or any other suitable information. As another more particular example, in some embodiments, the mechanisms can control dynamic lights that indicate any suitable information.

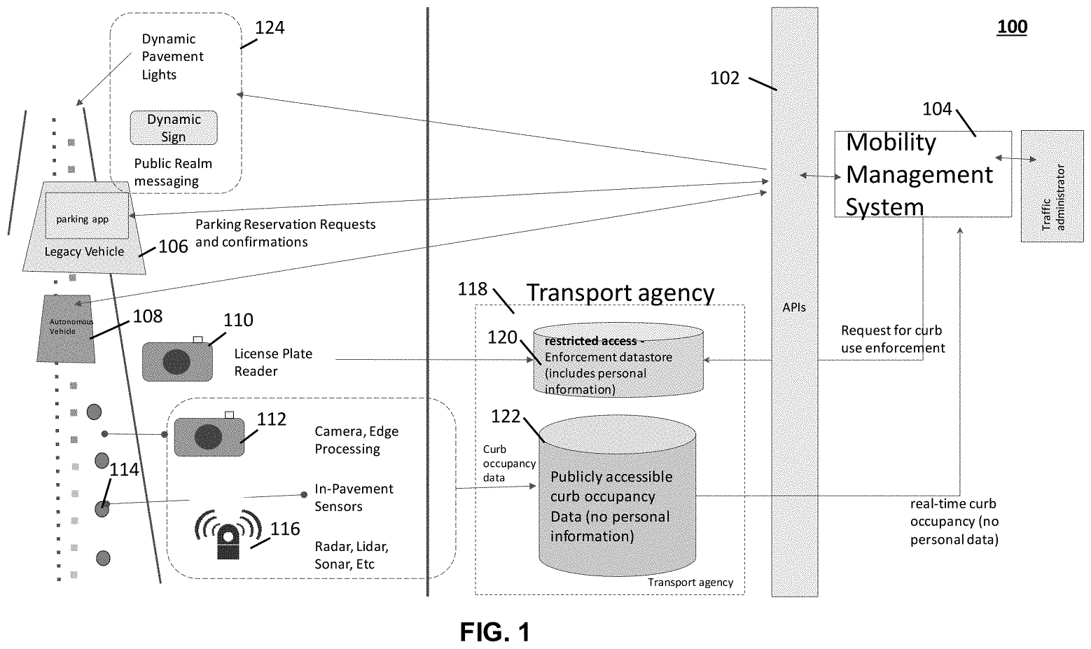

Turning to FIG. 1, an illustrative example 100 of a schematic diagram for coordinating parking availability is shown in accordance with some embodiments of the disclosed subject matter. In some embodiments, as illustrated in FIG. 1, diagram 100 can include an API 102, a mobility management system 104, one or more vehicles (e.g., a legacy vehicle 106, an autonomous vehicle 108, and/or any other suitable vehicles), one or more sensors (e.g., a license plate reader 110, a camera 112, in-pavement sensors 114, and/or any other sensors 116), a transport agency 118, and/or a messaging system 124.

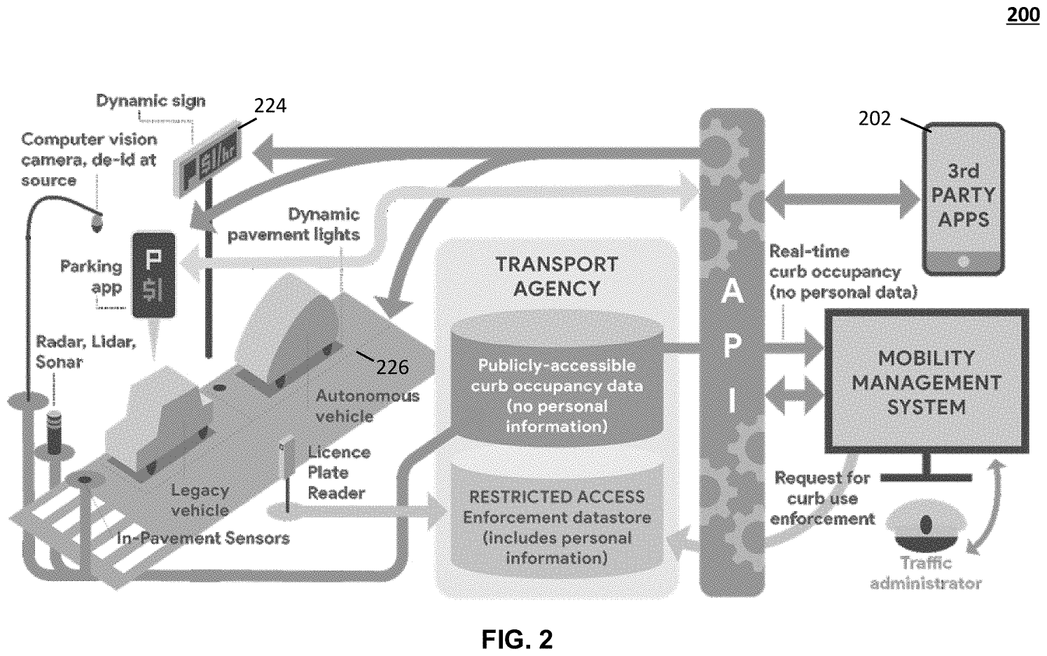

In some embodiments, API 102 can be used to collect data relating to parking spots and provide the collected data and/or information related to the collected data to any suitable entities. For example, in some embodiments, API 102 can be used by any suitable parking application (e.g., a parking application 202 as shown in FIG. 2) to indicate available parking spots in a particular area and to receive a reservation of an available spot (e.g., a reservation at a particular date and/or time for a particular duration of time, and/or any other suitable reservation) by a particular vehicle (e.g., legacy vehicle 106 and/or autonomous vehicle 108).

As another example, in some embodiments, API 102 can be used to transmit data to and/or from mobility management system 104 from sensors 110-116 and/or from transport agency 118. As a more particular example, in some embodiments, data transmitted via API 102 can include whether a vehicle is currently parked in a particular spot, whether a license plate of a vehicle parked in a particular spot matches a license plate of a vehicle that has reserved and/or paid for the particular spot, and/or any other suitable data.

As yet another example, in some embodiments, API 102 can be used to control messaging system 124. As a more particular example, in some embodiments, API 102 can be used to present a message on a sign associated with messaging system 124 that indicates any suitable information, such as a cost associated with a parking spot, a number of available parking spots, and/or any other suitable information.

As a further example, in some embodiments, API 102 can be used to receive data mobility sensors that are associated with adaptive traffic signals. For example, the mobility sensors can include any suitable sensors, such as lidar and/or radar, which can be non-personal or de-identified at the sensor source. Such data from the mobility sensors integrated or otherwise associated with adaptive traffic signals can be used to create safer streets that prioritize pedestrian safety and can assess time to cross the street while eliminating unnecessary waits. In a more particular example, such data can be received by API 102, where mobility management system 104 can determine the total number of pedestrians waiting to cross an intersection, a schedule of the vehicles approaching the intersection, and/or the volume of ride-hail services routed in the direction of the intersection. In another more particular example, data from in-pavement sensors can be received by API 102 such that mobility management system 104 can determine the volume, the type of transit, and/or the schedule of streetcars, ride-hailing services, and other vehicles along a street having the in-pavement sensors. Based on one or more of these pieces of determined information, mobility management system 104 can transmit a priority instruction to the adaptive traffic signal—e.g., where the pedestrian crossing is prioritized and provided with a greater amount of signal time than others (e.g., streetcars and then vehicles).

In some embodiments, mobility management system 104 can be any suitable system (e.g., a server, a group of servers, and/or any other suitable system) for receiving data related to parking, performing any suitable analysis of data related to parking, and/or performing any other suitable functions. For example, in some embodiments, mobility management system 104 can communicate in any suitable manner with parking application 202 to allow available parking spots to be indicated in a user interface within parking application 202 and/or reserved using parking application 202. As another example, in some embodiments, mobility management system 104 can perform any suitable calculations that can be used to present a message using messaging system 124. As a more particular example, in an instance in which a message presented using a sign associated with messaging system 124 indicates a cost of parking which is determined based on a current demand for parking spots, mobility management system 104 can determine the current demand for parking spots based on any suitable information or data (e.g., based on a typical number of reservations for parking spots in the location at the current time of data, based on a whether a known event is taking place at the location, and/or based on any other suitable information).

It should be noted that mobility management system 104 can perform any suitable functions. For example, mobility management system 104 can coordinate roads, signals, lanes, and trip options. In another example, mobility management system 104 can use real-time data, such as data from API 102, to manage traffic volume and speed in light of transit delays, emergency dispatches, weather patterns, etc. In yet another example, mobility management system 104 can adapt to existing modes of transit (e.g., cars, bikes, pedestrians, streetcars, etc.), emerging modes of transit (e.g., autonomous vehicles, scooters, etc.), and future modes of transit. In a more particular example, mobility management system 104 can use data from traffic cameras, in-pavement detectors or sensors, and pedestrian detectors or sensors to determine how travelers are using different modes of transportation, can use one or more modelling tools to assist the transport system respond to real-time trip patterns, and can provide travelers with information (e.g., street closures, transit arrival times, ride-hail wait times, etc.) such that the traveler can make and/or adjust trip choices.

In some embodiments, sensors 110-116 can include any suitable sensors that determine whether a vehicle is parked in a particular parking spots and/or identify a vehicle that is currently parked in a particular parking spot. For example, in some embodiments, license plate reader 110 can include a camera that can detect a license plate of a vehicle parked in a particular parking spot and can identify a license plate number of the vehicle. As described above, in some embodiments, a detected license plate can then be used by transport agency 118 to enforce any suitable parking rules, such as determining whether a vehicle with the detected license plate number is allowed to be parked in the parking spot at a current time, and/or any other suitable rules. As another example, in some embodiments, camera 112 can be used to determine any suitable information based on images captured by camera 112. As a more particular example, in some embodiments, images captured by camera 112 can be used to determine whether a vehicle is currently parked in a particular parking spot, whether a particular parking spot is currently available, whether a vehicle parked in a particular parking spot has parked correctly (e.g., within lines marking a parking spot, within a predetermined distance to a curb, and/or any other suitable metric), and/or any other suitable information. As yet another example, in some embodiments, in-pavement sensors 114 and/or other sensors 116 can be used to determine any suitable information, such as whether a vehicle is currently parked in a parking spot, and/or any other suitable information. Note that, in some embodiments, other sensors 116 can include any suitable type of sensors, such as radar, lidar, sonar, and/or any other suitable type of sensors.

Note that, in some embodiments, any suitable combination of any suitable number of sensors 110-116 can be used. For example, in some embodiments, multiple in-pavement sensors can be used with each in-pavement sensor corresponding to a parking spot. As another example, in some embodiments, camera 112 can capture images corresponding to multiple parking spots (e.g., five, ten, twenty, and/or any other suitable number).

In some embodiments, transport agency 118 can correspond to any suitable entity. For example, in some embodiments, transport agency 118 can correspond to a government or other enforcement entity. In some embodiments, transport agency 118 can perform any suitable function(s). For example, in some embodiments, transport agency 118 can be associated with an enforcement database 120 that collects any suitable data from sensors 110-116 and/or any suitable information from mobility management system 104 and stores information related to parking by particular vehicles. As a more particular example, in some embodiments, transport agency 118 can determine that a particular vehicle has parked illegally (e.g., has parked in a parking spot reserved by another vehicle, has parked in a parking spot for longer than a duration of time reserved by the vehicle, has not parked within lines marking edges of the parking spot, and/or parked illegally in any other suitable manner) and can store an indication of the illegally parked vehicle in enforcement database 120. In some such embodiments, information determined by transport agency 118 can be used by any suitable entity to enforce parking rules (e.g., by sending a ticket to an owner of an illegally parked vehicle, and/or in any other suitable manner). Note that, in some embodiments, information included in enforcement database 120 can include personally identifying information, such as license plate information, names of owners of a vehicle associated with a particular license plate, driver's license information, and/or any other suitable personally identifying information. In some such embodiments, information stored by enforcement database 120 can be protected in any suitable manner, for example, using any suitable encryption protocol(s).

As another example, in some embodiments, transport agency 118 can be associated with a curb occupancy database 122. In some embodiments, curb occupancy database 122 can store any suitable data or information received from sensors 110-116 that indicate availability of particular parking spots. For example, in some embodiments, curb occupancy database can include indications of a group of parking spots, and can update (e.g., in real-time) availability of each parking spot in the group of parking spots based on data collected by sensors 110-116. In some such embodiments, mobility management system 104 and/or parking application 202 can transmit a query to curb occupancy database 122 to identify available and/or unavailable parking spots. For example, in some embodiments, parking application 202 can transmit a query to curb occupancy database 122 to determine currently available parking spots that can be reserved by any suitable vehicles. As another example, in some embodiments, mobility management system 104 can transmit a query to curb occupancy database 122 to construct a model of demand for parking at different times (e.g., different times of day, different days of the week, and/or any other suitable times) for any suitable purpose (e.g., to set a price for a parking spot at a current time, and/or for any other suitable purpose).

In some embodiments, messaging system 124 can include any suitable signs, lights, and/or any other suitable messaging devices. For example, in some embodiments, as shown in FIG. 2, messaging system 124 can include a dynamic sign 224. In some embodiments, dynamic sign 224 can present any suitable message, such as a current cost of a parking spot (e.g., $1 per hour, and/or any other suitable cost), a current number of available parking spots in a particular area, and/or any other suitable information that can be updated at any suitable time. As another example, in some embodiments, messaging system 124 can include dynamic pavement lights (e.g., dynamic pavement lights 226, as shown in FIG. 2). In some embodiments, the dynamic pavement lights can include any suitable information, such as whether a particular parking spot is available, whether a particular parking spot will soon become available (e.g., because a reservation of the spot is due to expire soon), and/or any other suitable information. In some embodiments, the dynamic pavement lights can indicate information in any suitable visual manner, for example, using a color of the lights (e.g., where green indicates a parking spot is available, where yellow indicates a parking spot is soon to become available, and/or any other suitable color indication), using a blinking pattern of the lights, and/or in any other suitable manner. In another example, the dynamic pavement lights can use a particular color or light pattern (e.g., flashing yellow lights) to alert and/or direct a particular driver of a vehicle to a particular parking spot, to alert vehicles and/or pedestrians that a particular space is being reserved for pick-ups and drop-offs associated with one or more ride-hail services. In some embodiments, API 102 can be used to control any components of messaging system 124.

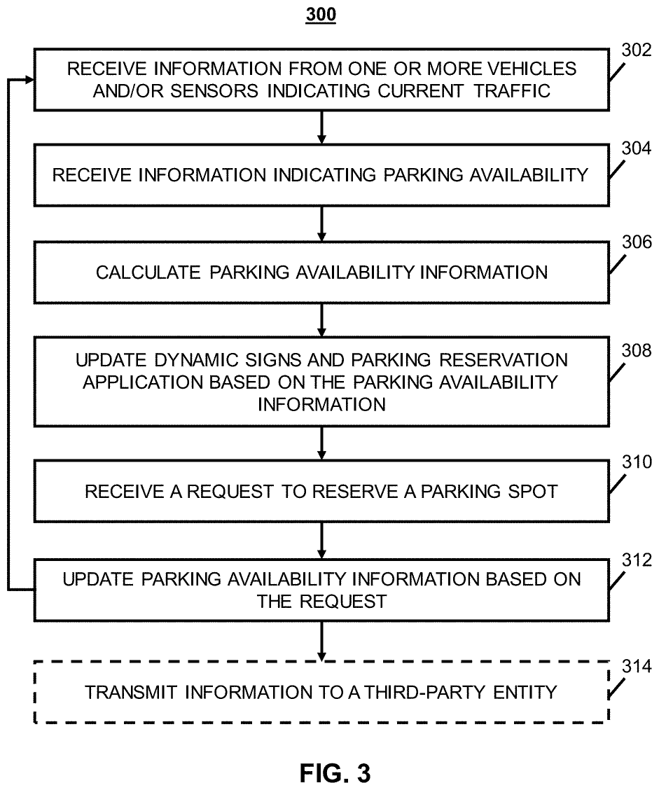

Turning to FIG. 3, an illustrative example 300 of a process for coordinating parking availability is shown in accordance with some embodiments of the disclosed subject matter. In some embodiments, blocks of process 300 can be executed by any suitable device, such as a server associated with a mobility management system, as shown in and described above in connection with FIGS. 1 and 2.

Process 300 can begin at 302 by receiving information from one or more vehicles and/or sensors. In some embodiments, process 300 can receive any suitable information. For example, in some embodiments, process 300 can receive current vehicle location information from one or more vehicles that indicates locations of the vehicle (e.g., using GPS coordinates, and/or in any other suitable manner). As a more particular example, in some embodiments, process 300 can receive information indicating that a particular number of vehicles are in a particular geographic region. As a specific example, in some embodiments, process 300 can receive information indicating that a particular number of vehicles are within a predetermined distance range (e.g., 500 feet, 1000 feet, and/or any other suitable distance) to a particular parking lot or parking garage. As another example, in some embodiments, process 300 can receive any suitable information from any suitable sensors that indicate information such as a current traffic level in a particular geographic region. As a more particular example, in some embodiments, process 300 can receive information from any suitable cameras, motion sensors, and/or any other suitable sensors that indicate that a particular number of vehicles are in a particular geographic region (e.g., within a particular distance range of a particular parking lot or parking garage). Note that, in some embodiments, any suitable information received by process 300 can be de-identified in any suitable manner. For example, in some embodiments, a camera image that indicates a particular vehicle at a location can be de-identified by removing any visible license information.

Note that, in some embodiments, process 300 can receive any other suitable information at 302. For example, in some embodiments, process 300 can receive scheduling information indicating that an event is to occur at a particular location and/or at a particular time, thereby indicating that there is likely to be a high demand for parking at a particular parking lot or garage near the location. As another example, in some embodiments, process 300 can receive information indicating public transit schedules, and/or any other suitable scheduling information.

At 304, process 300 can receive information indicating parking availability. For example, as shown in and described above in connection with FIG. 1, in some embodiments, process 300 can receive information from any suitable sensors that indicate whether a vehicle is parked in a particular parking spot. As a more particular example, in some embodiments, process 300 can receive image data from a camera that can be used to detect a license plate of a vehicle parked in a particular parking spot and can identify a license plate number of the vehicle. As another more particular example, in some embodiments, process 300 can receive image data from a camera that can be used to determine any other suitable information, such as whether a vehicle is currently parked in a particular parking spot, whether a particular parking spot is currently available, whether a vehicle parked in a particular parking spot has parked correctly (e.g., within lines marking a parking spot, within a predetermined distance to a curb, and/or any other suitable metric), and/or any other suitable information. As yet another more particular example, in some embodiments, process 300 can receive information from any suitable in-pavement sensors and/or other sensors that can be used to determine any suitable information, such as whether a vehicle is currently parked in a parking spot, and/or any other suitable information. Note that, in some embodiments, the sensors can include any suitable type of sensors, such as radar, lidar, sonar, and/or any other suitable type of sensors.

As another example, in some embodiments, process 300 can receive information from any suitable database that stores parking information, such as whether a vehicle is currently parked in a particular spot, a duration of time a vehicle has reserved a particular parking spot for, and/or any other suitable information. In some embodiments, the database can be associated with any suitable entity, such as a mobility management system associated with the server executing process 300, a third-party entity such as a transport agency (such as shown in and described above in connection with FIGS. 1 and 2), and/or any other suitable entity.

At 306, process 300 can calculate parking availability information based on the information received at blocks 302 and 304. In some embodiments, the parking availability information can include any suitable information. For example, in some embodiments, the parking availability information can include a number of currently available parking spots in a particular parking lot or garage. As a more a particular example, in some embodiments, process 300 can determine that there are a total number of parking spots in a particular garage, and that, based on the information received at block 304, that a particular number of spots are currently occupied by vehicles. Continuing with this example, process 300 can then determine a number of currently available parking spots based on the total number of spots and the number of currently occupied spots.

As another example, in some embodiments, the parking availability information can include a current price of a parking spot in a particular parking lot or garage. As a more particular example, in some embodiments, process 300 can calculate a current price of a parking spot based on a predicted demand for parking spots in a particular parking lot and/or based on a number of currently available parking spots. As a specific example, in some embodiments, process 300 can predict a demand for parking spots in a particular parking lot based on any suitable information received at block 302, such as a current level of traffic in a geographic region in which the parking lot is located, whether an event is scheduled in a geographic region in which the parking lot is located, and/or any other suitable information. Continuing with this example, in some embodiments, process 300 can then calculate a price of a parking spot based on the predicted demand and based on a current number of available parking spots. Continuing further with this example, in an instance in which process 300 predicts a high demand for parking spots in a particular garage at a particular time (or during a particular time window), and in which process 300 determines that there are fewer than a predetermined number of parking spots available, process 300 can determine that the price of a parking spot in the garage is to be higher than a typical price (e.g., 30% higher, 40% higher, and/or any other suitable price increase). Conversely, in an instance in which process 300 predicts a relatively low demand for parking spots in a particular garage at a particular time (or during a particular time window), process 300 can determine that the price of a parking spot in the garage is to be a typical price and/or lower than a typical price (e.g., 30% lower, 40% lower, and/or any other suitable price). Note that, in some embodiments, an amount of a price increase and/or a price decrease can be based on the predicted demand.

As another more particular example, in some embodiments, process 300 can calculate different prices for a parking spot in a particular garage for different vehicles. As a specific example, in some embodiments, process 300 can calculate a first price for a relatively small vehicle (e.g., a compact car, and/or any other suitable small vehicle), and can calculate a second price for a relatively larger vehicle (e.g., a non-compact car, a van, a bus, and/or any other suitable larger vehicle).

At 308, process 300 can update any suitable dynamic signs and/or information used by a parking reservation application based on the parking availability information. In some embodiments, the dynamic signs can include any suitable sigs or messaging systems, such as messaging system 124, as shown in and described above in connection with FIG. 1. For example, in some embodiments, process 300 can update any suitable dynamic signs, which can include any suitable signs, lights, and/or any other suitable messaging devices. As a more particular example, in some embodiments, process 300 can transmit instructions to a dynamic sign to cause the dynamic sign to indicate any suitable information, such as a current cost of a parking spot (e.g., $1 per hour, and/or any other suitable cost), a current number of available parking spots in a particular area, and/or any other suitable information, as shown in and described above in connection with FIG. 2. As another more particular example, in some embodiments, process 300 can cause dynamic pavement lights (e.g., dynamic pavement lights 226, such as shown in and described above in connection with FIG. 2) to indicate any suitable information, such as whether a particular parking spot is available, whether a particular parking spot will soon become available (e.g., because a reservation of the spot is due to expire soon, as determined based on information received at block 304), and/or any other suitable information. In some embodiments, process 300 can transmit instructions to the dynamic pavement lights such that the dynamic pavement lights indicate information in any suitable visual manner, for example, by altering a color of the lights (e.g., where green indicates a parking spot is available, where yellow indicates a parking spot is soon to become available, and/or any other suitable color indication), by altering a blinking pattern of the lights, and/or in any other suitable manner. In another example, process 300 can transmit instructions to the dynamic pavement lights that cause the dynamic pavement lights to use a particular color or light pattern (e.g., flashing yellow lights) to alert and/or direct a particular driver of a vehicle to a particular parking spot, to alert vehicles and/or pedestrians that a particular space is being reserved for pick-ups and drop-offs associated with one or more ride-hail services.

It should be noted that, in some embodiments, dynamic pavement lights and other components of a parking spot can be used to repurpose the parking spot and adjacent parking spots for community space or gatherings, such as a pop-up street fair or a sidewalk expansion, where such a change in use can be indicated via the dynamic pavement lights.

In some embodiments, process 300 can update information used by a parking reservation application with any suitable information that can be used by any suitable device to reserve a parking spot in a particular parking lot or garage. In some embodiments, process 300 can update the information used by the parking reservation application in any suitable manner. For example, in some embodiments, process 300 can update the information to indicate a currently available number of parking spots in a particular parking lot or garage. As another example, in some embodiments, process 300 can update the information to indicate a current pricing of a parking spot in a particular parking lot or garage, such as described above in connection with block 306. As yet another example, in some embodiments, process 300 can update the information to indicate a predicted demand for parking spots in particular parking lot or garage. As a more particular example, in some embodiments, process 300 can update the information to indicate a prediction that there is likely to not be many available parking spots in a particular lot or garage during a particular time window (e.g., on a particular day, during particular hours on a particular day, and/or any other suitable time window).

At 310, process 300 can receive a request to reserve a particular parking spot. In some embodiments, process 300 can receive the request in any suitable manner. For example, as described above in connection with FIGS. 1 and 2, in some embodiments, process 300 can receive a request from any suitable device (e.g., a mobile phone, a wearable computer, a virtual assistant device, a laptop computer, a tablet computer, a desktop computer, a vehicle entertainment or information system, a parking kiosk, and/or any other suitable device) that is executing the parking reservation application. In some embodiments, the request can include any suitable information, such as a license plate of the vehicle that is to be parked in the spot, a name of a driver of the vehicle, a duration of time the vehicle is to be parked in the spot, payment information (e.g., credit card information, account information associated with any suitable payment service(s), and/or any other suitable payment information), and/or any other suitable information. Note that, in some embodiments, information included in the request can be explicitly provided by a user of the parking reservation application. Additionally or alternatively, in some embodiments, information included in the request can be automatically captured by any suitable device or sensor, such as a camera that detects and/or identifies a license plate number of a vehicle occupying a particular parking space.

Additionally, note that, in some embodiments, process 300 can receive the request to reserve the parking spot at any suitable time relative to a time the parking spot will be used. For example, in some embodiments, process 300 can receive the request in advance of the time the parking spot will be used (e.g., an hour before the spot will be used, a day before the spot will be used, and/or any other suitable time). As another example, in some embodiments, process 300 can receive the request after a vehicle has been parked in the parking spot to be reserved. As a more particular example, in some embodiments, process 300 can receive the request from a user device associated with a driver of the vehicle and/or from a parking kiosk after the driver of the vehicle has parked the vehicle in the parking spot.

Note that, in some embodiments, in response to receiving the request, process 300 can determine whether the parking spot indicated in the request is available during the requested time window. For example, in some embodiments, process 300 can determine based on current parking availability information and/or based on other received parking reservations, whether the requested parking spot will be available during the requested time window. Conversely, in some embodiments, process 300 can only cause indications of available parking spots to be presented in the parking reservation information such that a request for a parking spot is received for available spots. For example, in some embodiments, the parking reservation application can indicate a list of available parking spots during a particular time window (e.g., parking spots available on Saturday between 9 a.m. and noon, and/or any other suitable time window), and the request can be received based on the list of available parking spots (e.g., in response to a user of a user device executing the parking reservation application selecting a representation of an available parking spot included in the list). In some such embodiments, the list can be presented based on any suitable filtering. For example, in some embodiments, a user of the parking reservation application can request that parking spots that have not yet been reserved in a particular parking garage during a particular time window be presented, and, in some embodiments, process 300 can cause a list of parking spots matching the filtering criteria to be presented.

Furthermore, note that, in some embodiments, process 300 can verify information provided in the request to reserve the parking spot with information related to the vehicle parked in the reserved spot at any suitable time(s). For example, as described above in connection with FIGS. 1 and 2, process 300 can verify that a license plate of a parked vehicle matches a license plate associated with the reservation. As another example, in an instance in which the request to reserve the parking spot is for a vehicle of a particular size (e.g., a compact vehicle, and/or any other suitable size vehicle), process 300 can verify the size of the parked vehicle in any suitable manner (e.g., using camera images that include the parked vehicle, using any suitable sensors, and/or in any other suitable manner). In some embodiments, in response to determining that information included in the request to reserve the parking spot does not match information associated with the vehicle, process 300 can perform any suitable action(s), such as transmitting a message to any suitable transport agency or enforcement agency, as described above in connection with FIGS. 1 and 2.

At 312, process 300 can update parking availability information based on the request. In some embodiments, process 300 can update the parking availability information in any suitable manner. For example, in some embodiments, process 300 can update any suitable database to indicate that the parking spot indicated in the request received at block 310 has been reserved for the time window indicated in the request. Note that, in some embodiments, process 300 can facilitate any suitable payment for reservation of the parking spot via any suitable payment service(s).

Note that, in some embodiments, process 300 can automatically update parking availability based on information other than a received request for a parking spot. For example, in an instance in which process 300 receives information indicating than an event is to be held in proximity to a particular parking lot or parking garage (e.g., information received as described above in connection with block 302), process 300 can automatically cause any particular parking spots to be reserved for any suitable purpose. For example, in some embodiments, process 300 can identify parking spots closest to an entrance for the event and can cause the identified spots to be reserved for picking up and/or dropping off passengers. As another example, in some embodiments, process 300 can identify parking spots closest to an entrance for the event and can cause the identified spots to be reserved as accessible spots. In some embodiments, parking spots automatically identified and/or reserved by process 300 can be updated in any suitable database and can be indicated in the parking reservation application similar to parking spots manually reserved by users.

In some embodiments, process 300 can loop back to 302 and can continue receiving information from any suitable vehicles and/or sensors. Note that, in some embodiments, process 300 can receive requests to reserve parking spots (e.g., as shown in and described above in connection with block 310) at any suitable time point(s).

In some embodiments, process 300 can, at 314, transmit any suitable information to a third-party. For example, as described above in connection with FIGS. 1 and 2, process 300 can transmit information indicating that a particular parking spot has been reserved (e.g., a spot indicating in the request received at block 310) to a third-party that maintains a parking database. As another example, as described above in connection with FIGS. 1 and 2, process 300 can transmit information indicating any violations detected by process 300. As a more particular example, as described above, in an instance in which process 300 detects that a license plate of a vehicle parked in a particular spot does not match a license plate associated with a reservation for the spot, process 300 can transmit information to a third-party transport agency or enforcement agency indicating the detected license plate mismatch. As another more particular example, in an instance in which process 300 determines that a vehicle has remained parked in a spot for longer than a time window during which the spot was reserved, process 300 can transmit information to the transport agency or enforcement agency that indicates a duration of time the vehicle was parked in the spot that exceeds the reserved time.

Note that, in some embodiments, communication between a server executing process 300 and any suitable devices (e.g., user devices, sensors, third-party databases, and/or any other suitable databases) can be via any suitable API, such as API 102, as shown in and described above in connection with FIG. 1

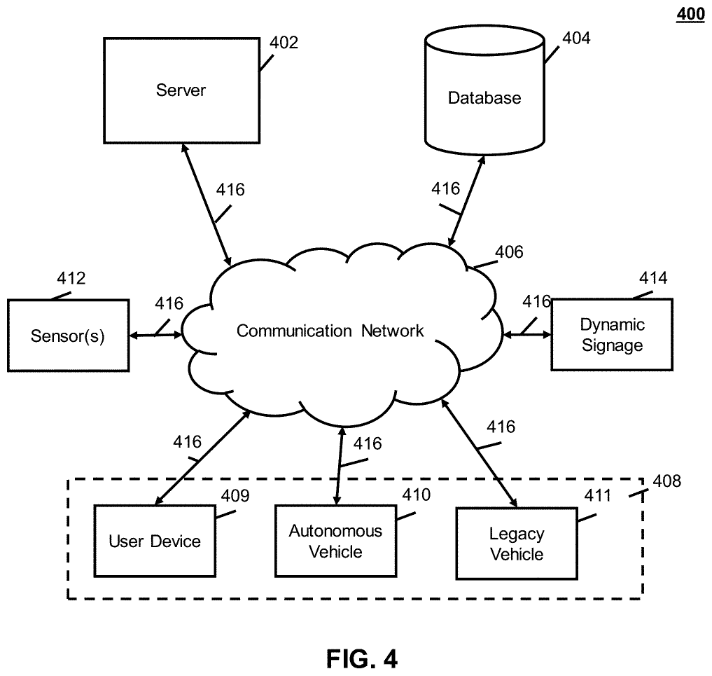

Turning to FIG. 4, an illustrative example 400 of hardware for coordinating parking availability that can be used in accordance with some embodiments of the disclosed subject matter is shown. As illustrated, hardware 400 can include a server 402, a database 404, a communication network 406, one or more devices or vehicles 408 that can be used to reserve parking or to park in an available space, sensors 412, and/or dynamic signage 414.

Server 402 can be any suitable server(s) for storing information, data, programs, and/or any other suitable content. In some embodiments, server 402 can perform any suitable function(s). For example, in some embodiments, server 402 can receive information from any suitable user devices (e.g., mobile phones, wearable computers, tablet computers, desktop computers, vehicle-based information or entertainment systems, and/or any other suitable user devices) for reserving a parking spot. As another example, in some embodiments, server 402 can receive vehicle location information from any suitable user devices or vehicles that allow server 402 to determine parking availability or parking demand in a particular area. As yet another example, in some embodiments, server 402 can receive information from sensors 412 that indicate traffic in a particular area and/or whether a particular parking spot is occupied, as described above in connection with FIG. 1. As still another example, in some embodiments, server 402 can update dynamic signage that indicates parking availability, as described above in connection with FIGS. 1 and 2. As still another example, in some embodiments, server 402 can calculate any suitable parking-related information (e.g., a cost of a parking spot based on demand, a number of available parking spots in a particular lot or garage, and/or any other suitable information), as described above in connection with FIG. 1.

In some embodiments, database 404 can store any suitable information. For example, in some embodiments, database 404 can store a total number of spots in a particular parking lot or garage. As another example, in some embodiments, database 404 can store license plate numbers of vehicles that are currently occupying particular parking spots, such as described above in connection with FIG. 1. In some embodiments, database 404 can be associated with any suitable entity. For example, in some embodiments, database 404 can be associated with a mobility management service that coordinates parking availability. As another example, in some embodiments, database 404 can be associated with any suitable third-party entity, such as a database that stores curb occupancy data (such as shown in and described above in connection with FIG. 1), a database associated with any suitable enforcement agency (such as shown in and described above in connection with FIG. 1), and/or any other suitable entity.

Communication network 406 can be any suitable combination of one or more wired and/or wireless networks in some embodiments. For example, communication network 406 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. In some embodiments, devices 408 can be connected by one or more communications links (e.g., communications links 416) to communication network 406 that can be linked via one or more communications links (e.g., communications links 416) to server 402, database 404, sensors 412, and/or dynamic signage 414. The communications links can be any communications links suitable for communicating data among server 402, database 404, devices 408, sensors 412, and/or dynamic signage 414, such as network links, dial-up links, wireless links, hard-wired links, any other suitable communications links, or any suitable combination of such links.

Devices 408 can include any one or more devices for reserving a parking spot and/or occupying a parking spot, such as a user device 409, an autonomous vehicle 410, and/or a legacy vehicle 411. Note that, in some embodiments, user device 409 can include any suitable type of user device, such as a mobile phone, a wearable computer, a tablet computer, a desktop computer, a laptop computer, a vehicle entertainment or information device, a virtual assistant device, and/or any other suitable type of device. In some embodiments, user device 409 can be capable of executing any suitable parking application that can be used, for example, to reserve a parking spot, check parking spot availability in a particular location, pay a fee to park in a particular spot, and/or perform any other suitable function(s), such as shown in and described above in connection with FIGS. 1 and 2.

In some embodiments, sensors 412 can be any suitable sensors for collecting any suitable data. For example, in some embodiments, sensors 412 can collect data indicating current traffic in a particular area, whether a particular parking spot is currently occupied, and/or any other suitable information, as shown in and described above in connection with FIGS. 1 and 2. In some embodiments, sensors 412 can include any suitable type(s) of sensors, such as, such as radar, lidar, sonar, and/or any other suitable type of sensors.

In some embodiments, dynamic signage 414 can include any suitable type of controllable signage or other indicators. For example, as shown in and described above in connection with FIGS. 1 and 2, dynamic signage 414 can include a display that can be updated to indicate a current availability of parking spots in a particular lot or garage and/or a current price of parking in a particular lot or garage. As another example, in some embodiments, dynamic signage 414 can include dynamic pavement lights, such as shown in and described above in connection with FIG. 2.

Although server 402 is illustrated as one device, the functions performed by server 402 can be performed using any suitable number of devices in some embodiments. For example, in some embodiments, multiple devices can be used to implement the functions performed by server 402.

Although one user device 409, one autonomous vehicle 410, and one legacy vehicle 411 are shown in FIG. 4 to avoid over-complicating the figure, any suitable number of user devices and vehicles, and/or any suitable types of user devices and vehicles, can be used in some embodiments.

Although one sensor 412 is shown in FIG. 4 to avoid over-complicating the figure, any suitable number of sensors, and/or any suitable types of sensors, can be used in some embodiments.

Although one dynamic signage 414 is shown in FIG. 4 to avoid over-complicating the figure, any suitable number of dynamic signs, and/or any suitable types of dynamic signs, can be used in some embodiments.

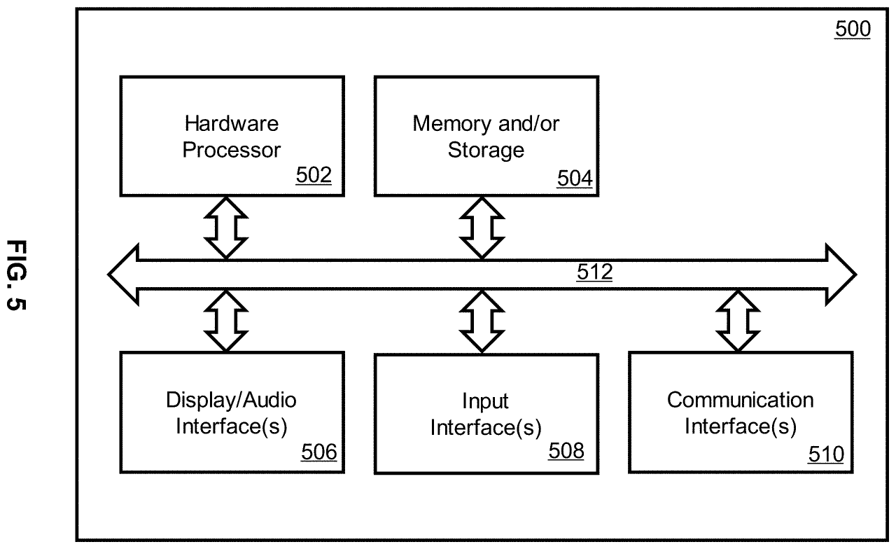

Server 402 and devices 408 can be implemented using any suitable hardware in some embodiments. For example, in some embodiments, devices 402 and 408 can be implemented using any suitable general-purpose computer or special-purpose computer. For example, a mobile phone may be implemented using a special-purpose computer. Any such general-purpose computer or special-purpose computer can include any suitable hardware. For example, as illustrated in example hardware 500 of FIG. 5, such hardware can include hardware processor 502, memory and/or storage 504, display/audio interface(s) 506, input interface(s) 508, communication interface(s) 510, and a bus 512.

Hardware processor 502 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 502 can be controlled by a server program stored in memory and/or storage of a server, such as server 402. In some embodiments, hardware processor 502 can be controlled by a computer program stored in memory and/or storage 504 of device 408.

Memory and/or storage 504 can be any suitable memory and/or storage for storing programs, data, and/or any other suitable information in some embodiments. For example, memory and/or storage 504 can include random access memory, read-only memory, flash memory, hard disk storage, optical media, and/or any other suitable memory.

Display/audio interface(s) 506 can be any suitable circuitry for controlling and driving output to one or more display/audio output devices in some embodiments. For example, display/audio interface(s) 506 can be circuitry for driving a touchscreen, a flat-panel display, a cathode ray tube display, a projector, a speaker or speakers, and/or any other suitable display and/or presentation devices.

Input interface(s) 508 can be any suitable circuitry for controlling and receiving input from one or more input devices in some embodiments. For example, input interface(s) 508 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Communication interface(s) 510 can be any suitable circuitry for interfacing with one or more communication networks (e.g., computer network 406). For example, interface(s) 510 can include network interface card circuitry, wireless communication circuitry, and/or any other suitable type of communication network circuitry.

Bus 512 can be any suitable mechanism for communicating between two or more components 502, 504, 506, and 510, in some embodiments.

Note that, in some embodiments, hardware 500 can include an antenna. In some embodiments, the antenna can be any suitable one or more antennas for wirelessly communicating with a communication network (e.g., communication network 406) in some embodiments.

Any other suitable components can be included in hardware 500 in accordance with some embodiments.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described herein collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personal information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for coordinating parking availability are provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for coordinating parking availability, the method comprising:
receiving, at a server, information indicating a number of available parking spots in a parking garage during a time window;
receiving, from a first user device via an instance of an application executing on the first user device, a request to reserve a parking spot in the parking garage during the time window;
determining whether the parking spot is available during the time window based on the received information;
in response to determining that the parking spot is available during the time window, updating parking availability information to indicate that the parking spot has been reserved during the time window;
causing the reservation of the parking spot to be indicated via an instance of the application executing on a second user device; and
transmitting, from the server to a dynamic sign during the time window, instructions that cause the dynamic sign to present a message that indicates at least the parking availability information.

2. The method of claim 1, further comprising:
receiving, at the server via one or more sensors, information indicating a presence of a vehicle associated with the request to reserve the parking spot at a time point outside of the time window; and
transmitting a message to a second server that indicates that the vehicle has been detected at the parking spot outside of the time window.

3. The method of claim 1, further comprising:
identifying a second parking spot that is available in the parking garage; and
transmitting instructions to a light source that cause the light source to emit a light pattern that indicates the availability of the second parking spot.

4. The method of claim 1, further comprising:
receiving information indicating that an event is to be held at a location within a predetermined proximity to the parking garage during a second time window;
identifying a plurality of parking spots in the parking garage; and
updating the parking availability information to indicate that the plurality of parking spots have been reserved during the second time window.

5. The method of claim 4, further comprising transmitting instructions to a light source that cause the light source to emit a light pattern, during the second time window, that indicate that the plurality of parking spots are unavailable.

6. The method of claim 4, further comprising causing indications of the unavailability of the plurality of parking spots to be indicated in the instance of the application executing on the first user device and the instance of the application executing on the second user device.

7. The method of claim 1, further comprising receiving, at the server from a plurality of sensors, information indicating a number of vehicles within a predetermined proximity to the parking garage.

8. A system for coordinating parking availability, the system comprising:
a server including a hardware processor that is configured to:
receive, at the server, information indicating a number of available parking spots in a parking garage during a time window;
receive, from a first user device via an instance of an application executing on the first user device, a request to reserve a parking spot in the parking garage during the time window;
determine whether the parking spot is available during the time window based on the received information;
in response to determining that the parking spot is available during the time window, update parking availability information to indicate that the parking spot has been reserved during the time window;
cause the reservation of the parking spot to be indicated via an instance of the application executing on a second user device; and
transmit, from the server to a dynamic sign during the time window, instructions that cause the dynamic sign to present a message that indicates at least the parking availability information.

9. The system of claim 8, wherein the hardware processor is further configured to:
receive, at the server via one or more sensors, information indicating a presence of a vehicle associated with the request to reserve the parking spot at a time point outside of the time window; and
transmit a message to a second server that indicates that the vehicle has been detected at the parking spot outside of the time window.

10. The system of claim 8, wherein the hardware processor is further configured to:
identify a second parking spot that is available in the parking garage; and
transmit instructions to a light source that cause the light source to emit a light pattern that indicates the availability of the second parking spot.

11. The system of claim 8, wherein the hardware processor is further configured to:
receive information indicating that an event is to be held at a location within a predetermined proximity to the parking garage during a second time window;
identify a plurality of parking spots in the parking garage; and
update the parking availability information to indicate that the plurality of parking spots have been reserved during the second time window.

12. The system of claim 11, wherein the hardware processor is further configured to transmit instructions to a light source that cause the light source to emit a light pattern, during the second time window, that indicate that the plurality of parking spots are unavailable.

13. The system of claim 11, wherein the hardware processor is further configured to cause indications of the unavailability of the plurality of parking spots to be indicated in the instance of the application executing on the first user device and the instance of the application executing on the second user device.

14. The system of claim 8, wherein the hardware processor is further configured to receive, at the server from a plurality of sensors, information indicating a number of vehicles within a predetermined proximity to the parking garage.

15. A non-transitory computer-readable medium containing computer executable instructions that, when executed by a processor, cause the processor to perform a method for coordinating parking availability, the method comprising:
receiving, at a server, information indicating a number of available parking spots in a parking garage during a time window;
receiving, from a first user device via an instance of an application executing on the first user device, a request to reserve a parking spot in the parking garage during the time window;
determining whether the parking spot is available during the time window based on the received information;
in response to determining that the parking spot is available during the time window, updating parking availability information to indicate that the parking spot has been reserved during the time window;
causing the reservation of the parking spot to be indicated via an instance of the application executing on a second user device; and
transmitting, from the server to a dynamic sign during the time window, instructions that cause the dynamic sign to present a message that indicates at least the parking availability information.

16. The non-transitory computer-readable medium of claim 15, wherein the method further comprises:
receiving, at the server via one or more sensors, information indicating a presence of a vehicle associated with the request to reserve the parking spot at a time point outside of the time window; and
transmitting a message to a second server that indicates that the vehicle has been detected at the parking spot outside of the time window.

17. The non-transitory computer-readable medium of claim 15, wherein the method further comprises:
identifying a second parking spot that is available in the parking garage; and
transmitting instructions to a light source that cause the light source to emit a light pattern that indicates the availability of the second parking spot.

18. The non-transitory computer-readable medium of claim 15, wherein the method further comprises:
receiving information indicating that an event is to be held at a location within a predetermined proximity to the parking garage during a second time window;
identifying a plurality of parking spots in the parking garage; and
updating the parking availability information to indicate that the plurality of parking spots have been reserved during the second time window.

19. The non-transitory computer-readable medium of claim 18, wherein the method further comprises transmitting instructions to a light source that cause the light source to emit a light pattern, during the second time window, that indicate that the plurality of parking spots are unavailable.

20. The non-transitory computer-readable medium of claim 18, wherein the method further comprises causing indications of the unavailability of the plurality of parking spots to be indicated in the instance of the application executing on the first user device and the instance of the application executing on the second user device.

21. The non-transitory computer-readable medium of claim 15, wherein the method further comprises receiving, at the server from a plurality of sensors, information indicating a number of vehicles within a predetermined proximity to the parking garage.
